(19) United States
(12) Patent Application Publication
(10) Pub. No.: US 2010/0088314 A1
(43) Pub. Date: Apr. 8, 2010

(54) Method and system for searching on internet

(76) Inventor: Shaobo Kuang, Lansdale, PA (US)

Correspondence Address: SHAOBO Kuang, 1243 Meadowview Cir, Lansdale, PA, 19446, US

(21) Appl. No.: 12/587,177

(22) Filed: Oct. 3, 2009

Related U.S. Application Data
(60) Provisional application No. 61/195,343, filed on Oct. 7, 2008.

(51) Int. Cl. G06F 17/30

(52) U.S. Cl. 707/733; 707/E17.014

(57) ABSTRACT

The present invention provides methods and systems for presenting users a search results with choices to display the results in a different sorting or ranking orders. The two or more sets of search results in a different sorting or ranking orders are displayed in the same page. The present invention provides methods and systems to assign truthiness scores to news, messages, or stories.

The present invention is based on the provisional Patent Application Ser. No. 61/195,343, filed on Oct. 7, 2008, titled “Method and System for Searching on Internet”.

### FIELD OF THE INVENTION

This invention relates to the technology of searching the Internet or a database. More particularly, it relates to methods for search engines to list search result by user preferred orders.

### BACKGROUND OF THE INVENTION

Due to the developments of new Internet technology, searching for information via PC, cellphone or other mobile device, has become very important to people's daily lives. For example, students will need to search the Internet for projects and essays, and travelers will need to search for local hotels and restaurants. Search engines like GOOGLE and YAHOO have done an excellent job of helping people search the Internet. They provide users with a huge amount of information. Each search engine, like GOOGLE or YAHOO, has its own technologies for ranking their data, and shows users the search results in a list ordered by their ranking. Most of the time, users only view the first or second pages of results. The rest of the search results are usually ignored. For example, a user searches hotels in New York City, and got a search result of about 9,900,000 records for hotels in New York City. The first two pages most likely show the other hotel guide site or very expensive hotels, like Hyatt New York Hotels. However, while some users may like the default search engine's ranking, other users may like to select their own ranking, such as sorting by price, or sorting by distance, or sorting by style. For example, users get a search list for “hotels in New York” ordered by price. They don't want see very expensive ones, nor do they want to see very cheap ones either. The current search engines do not provide any easy way to solve these problems. Now, search engines should not only provide users with massive information, but also help users to analyze this massive information. In recent popular social network systems, there are many useful and useless messages, news, or notes. Users need systems or methods to filter out those useless messages, news, or notes.

### SUMMARY OF THE INVENTION

It is therefore the objects of the present invention are intended to overcome the drawbacks of the conventional art.

Accordingly, an object of the present invention is to provide methods and systems, which allow users to select sorting order for the search results from a search engine.

Another object of the present invention is to provide methods and systems, which are, not only provide users with massive information, but also help users analyze the information.

Another object of the present invention is to provide methods and systems to provide a system functionally not only as an information search engine, but also information analysis engine.

Another object of the present invention is to provide methods and systems to show users the distribution of the search results among many sub-groups for their search queries.

Another object of the present invention is to provide methods and systems to dynamically propose the other ranking or sorting keys for a random given search query.

Another object of the present invention is to provide systems to rank or sort objects by their trueness.

Another object of the present invention is to provide a system or method to determine trueness scores to objects, which are news, messages, or stories.

Another object of the present invention is to provide a system or a method to review trueness of objects, which are news, messages, or stories.

Another object of the present invention is to provide systems or methods to rank or sort news, notices, messages, stories, or announcements by trueness scores.

Another object of the present invention is to provide systems or methods to automatically adjust trueness scores of news, notices, messages, stories, or announcements.

Another object of the present invention is to provide methods and systems to dynamically, based on the information about the user's characters or profile or special events, propose the other ranking or sorting keys for a random given search query.

Another object of the present invention is to provide methods and systems to automatically random match at least two uses or persons among a plurality of users, setup and maintain the connections between or among the selected or picked users.

Another object of the present invention is to provide methods and systems to allow people to make friends in a faster way.

A method of searching information over Internet according to the present invention comprising:

under control of a client system,
entering a search query, and submit it; and
in response to said submission, sending the said search query to a search engine server system,
   under control of a search engine server system,
receiving said search query request,
searching in database for the results matched said search query,
generating at least one set of the matched records, ordered by search engine ranking or sorting,
determining the other possible ranking or sorting keys for the said search query,
returning the results and the other possible ranking or sorting keys back to the client system,
   under control of the client system,
displaying the search results and the other possible ranking or sorting keys for the said search query for user's further selection.

A method of searching information over Internet according to the present invention further comprising:
determining possible sub-groups for each said other possible ranking or sorting keys,
generating a summary for said each subgroup, which includes sub-group's titles, number of the results in each sub-groups, or hot index of each sub-groups,
returning said results, said other possible ranking or sorting keys, and said summaries back to said client system,
under control of said client system,
displaying said results, said other possible ranking or sorting keys for said search query, and said summaries for users further selection or reference.

A trueness scoring system according to the present invention includes:
storage unit for storing a ID, URL, trueness scores, and descriptions for each news, notices, messages, videos, or stories;
receiving unit for receiving trueness scores for each said news, notices, messages, videos, or stories, which are assigned by users from news sites, search engines, or social networks;
assigning unit for assigning said received trueness scores to corresponding said news, notices, messages, videos, or stories, and storing the trueness scores in said storage unit;
time determine unit for determining a life time or period for each said news, notices, messages, videos, or stories;
trends analysis unit for analyzing the trends of average trueness scores per certain time of period, such trends of average daily or hourly trueness scores, for said news, notices, messages, videos, or stories;
finalization unit for, based on the trends analysis results, determining whether there is a final trueness scores, and if there is a final trueness scores, assigning a final trueness scores to said news, notices, messages, videos, or stories.

An instant matching method according to the present invention compromising: under control of a hosting system, this hosts a program, activities or event,
a) receive calls from a plurality of users for joining said program, activity or event;
b) for each user, based on the user's profile or the user's requests, randomly pick or select a matched partner;
c) switch said user to connect to said picked partner and maintain the connection between the user and the partner for their talking and chatting;
d) after a certain period of time, repeat steps b) to d).

### BRIEF DESCRIPTIONS OF THE DRAWINGS

FIG. 1 is a flow chart schematically showing an example of a search engine of the present invention.

FIG. 2 is a flow chart schematically showing an example of a search engine of the present invention.

FIG. 3 shows an example of a search result web page of the present invention.

FIG. 4 shows an example of group/sorting page of the present invention.

FIG. 5 is a flow chart schematically showing an example of proposing the other ranking or sorting keys for a given search query according to the present invention.

FIG. 6 shows an example of proposing ranking or sorting keys according to the present invention.

FIG. 7 shows schematically a trueness scoring system according to the present invention.

FIG. 8A is a data chart showing an example of the present invention.

FIG. 8B is a data chart showing another example of the present invention.

FIG. 9 is a block diagraph, structurally showing user profiles in a social network system.

FIG. 10 shows an instant matching system according to the present invention.

FIG. 11 is a block diagraph, showing steps of an instant matching method according to the present invention.

FIG. 12 is a block diagraph, showing steps of an instant matching method according to the present invention.

### DETAILED DESCRIPTION OF THE INVENTION

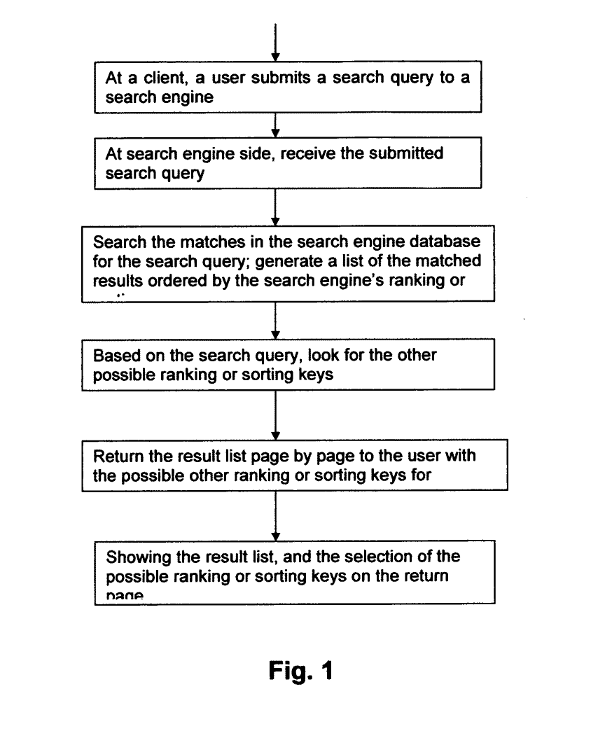

Referring now to the drawings, FIG. 1 shows a method of the present invention. Step 1, a user, from his client, submits a search query to a search engine. Step 2, the search engine receives the search query. Step 3, the search engine looks for the matches for the query in the search engine database, and generates a list of results ordered by the ranking or sorting defined by the search engine. Step 4, the search engine, based on the query and the corresponding information in the search engine database, determines the other possible ranking or sorting keys for the search results. Step 5, the search engine returns the result list and the other possible ranking or sorting keys back to the client. Step 6, at the client, it shows results and the selection for the other possible ranking or sorting keys on the search result web page.

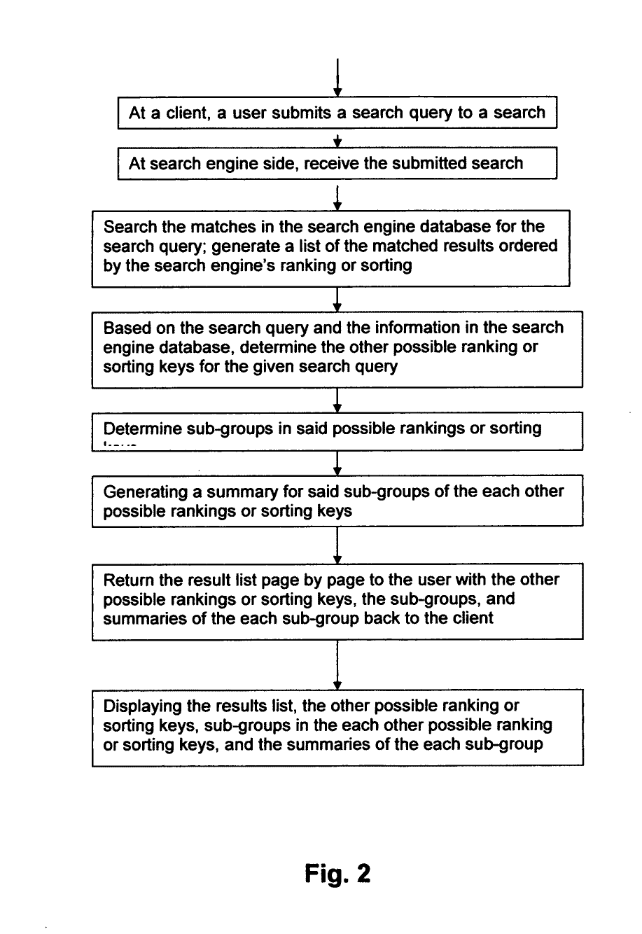

FIG. 2 shows a method of the present invention. Step 1, a user, from his client, submits a search query to a search engine. Step 2, the search engine receives the search query. Step 3, the search engine looks for the matches for the query in the search engine database, and generates a list of results ordered by the ranking or sorting defined by the search engine. Step 4, the search engine, based on the query and the corresponding information in the search engine database, determines the other possible ranking or sorting keys for the search results. Step 5, the search engine determines sub-groups with the each said ranking or sorting keys. Step 6, the search engine generates a summary for the each sub-group of the ranking or sorting keys. Step 7, the search engine returns the result list, the other possible ranking or sorting keys, the sub-groups in the other possible ranking or sorting keys, and the summaries of the each sub-groups back to the client. Step 8, at the client, it shows results, and the selections for the other possible ranking or sorting keys, and the selection for the sub-groups in the other possible ranking or sorting keys.

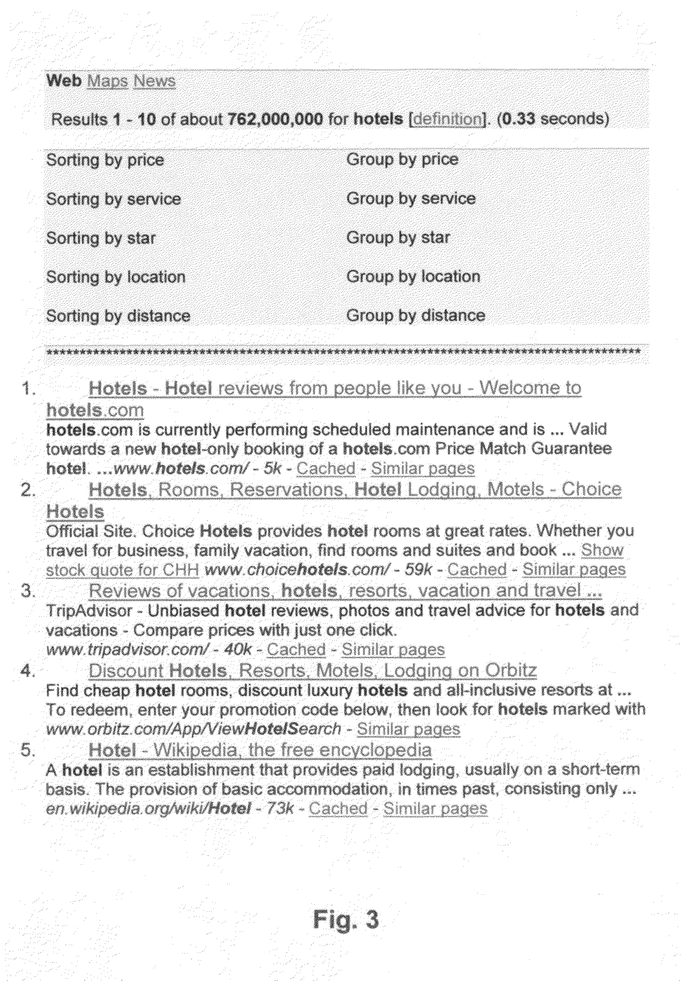

FIG. 3 shows an example a web page showing a search result page for a submitted search query “hotels”. Above the results list, it shows the other possible ranking or sorting keys for the search results of “hotels”. It includes “sorting by price”, “sorting by service”, “sorting by star”, “sorting by location” and “sorting by distance”. It also includes “group by price”, “group by service”, “group by star”, “group by location” and “group by distance”. In the example, the each other possible ranking or sorting key includes a single key, such as “price” or “service”. It can also include composite keys, such as sorting by “price and service”, which allows the user easily find out the best service hotels within his best price range. The purpose for these selection choices for the other possible ranking or sorting keys and groups is to help users to find the best answer for his or her search query faster and more accurate.

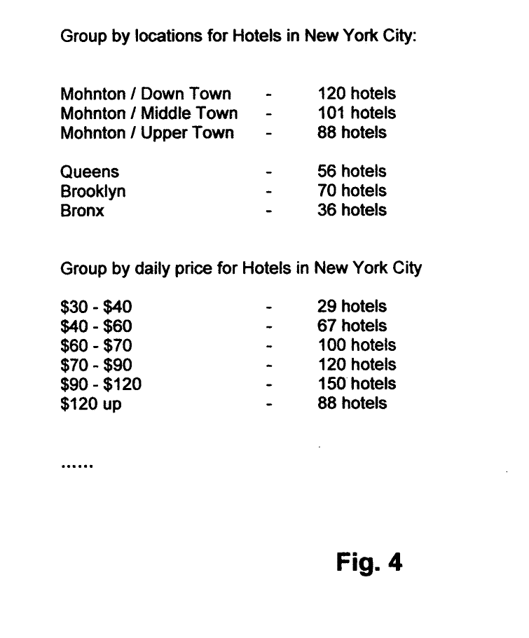

FIG. 4 shows a detail page for the sub-groups within the each other possible ranking or sorting keys, and the summaries for the each sub-group. For example, “group by location” for the search query “hotels in New York City” includes 56 hotels in Queens, 70 hotels in Brooklyn, and 36 hotels in Bronx. From FIG. 4, users will easily find out that, in New York City, most hotels are in the price range $90-$120. In this case, the summaries show the distribution (total number) information in the each sub-group. It can also show the other information, or even graphically show, such as stars or flags, for the given search query to allow users easily to find out the information they want. In this case, users can easily jump into the records, he or she is looking for, form a list of thousands records. This will make people less depends on first one or two pages from search result lists. Unlike the current data warehouse technology, the other possible ranking or sorting keys in the present invention are dynamically determined. The main different between data warehouse and search engine is that data in data warehouse are organized very well and can be easily managed while the information in search engine are not organized well and can not be easily managed. For example, for a search query “news” can have other possible sorting by region. However, searching “Hong Kong news”, it is not necessary to have a sorting by region; it may have sorting by languages, such as English, Traditional Chinese, and Simplified Chinese.

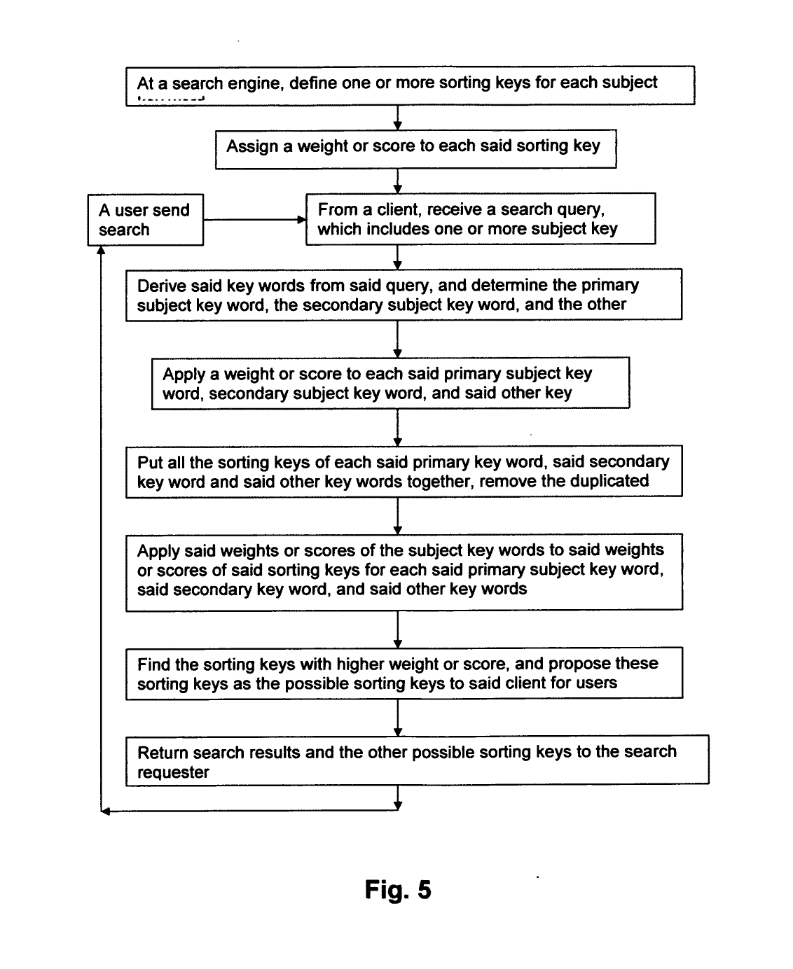

FIG. 5 shows a method of dynamic proposing ranking or sorting keys for a random give search query. First, at a search engine, define one or more ranking or sorting keys for each subject key word, and assign a weight or score to each said sorting key. When receive a random search query from a client, the search engine derives one or more subject key words from the search query, and determine primary key word, secondary key word, and other key words among the derived key words. Also, the search engine will assign a weight or score to the each primary, secondary and the other key words. Then, the search engine looks for the ranking or sorting keys for each said key words, discards the duplicated ranking or sorting keys, ands applies the weights or the scores of the key words to the weights or scores of the corresponding ranking or sorting keys for each the key word, proposes the ranking or sorting keys with higher weights or scores to the search query requester.

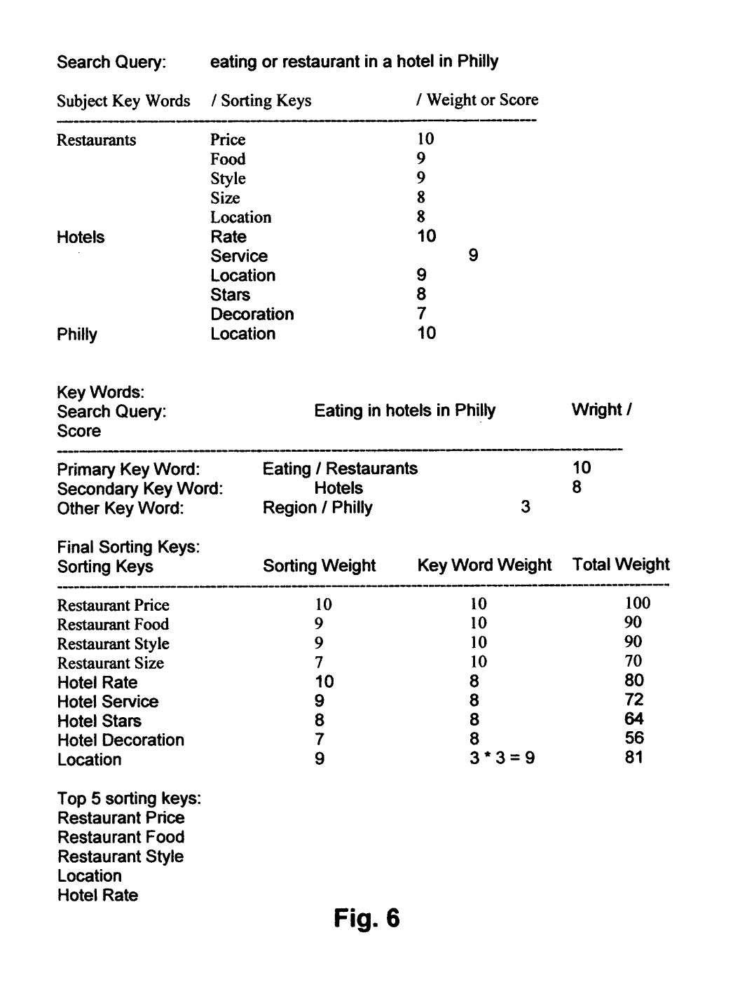

FIG. 6 shows an example according to the method in FIG. 5. The given search query is “Eating or restaurant in a hotel in Philly”. The derived subject key words are “eating or restaurant”, “hotel” and “Philly”. The search engine gives the key word “restaurant” a weight or score 10, gives the key word “hotel” a weight or score 8, and gives the key word “Philly” a weight or score 3. The pre-defined ranking or sorting keys for “Restaurant” are “Price”, “Food”, “Style”, “Size” and “Location”. The pre-defined ranking or sorting keys for “Hotel” are “Rate”, “Service”, “Location”, “Stars”, and “Decoration”. In FIG. 6, the each ranking or sorting key has a weight or a score. For example, the ranking or sorting key “Price” for the key word “Restaurant” has a weight or score 10, while the ranking or sorting key “Location” for the key word “Hotel” has a weight or score 9. By applying the weights or scores of the sorting keys to the weights or scores of the corresponding key words, we have “Restaurant Price” with a total weight or score 100, “Restaurant Food” with a total weight or score 90, “Restaurant Style” with a total weight or score 90, “Restaurant Size” with a total weight or score 70, “Hotel Rate” with a total weight or score 80, “Hotel Service” with a total weight or score 72, “Hotel Stars” with a total weight or score 64, “Hotel Decoration” with a total weight or score 56, and “Location” with a total weight or score 81. The top 5 higher weights or scores ranking or sorting keys are “Restaurant Price”, “Restaurant Style”, “Restaurant Recommendation”, “Location” and “Hotel Rate”. These 5 ranking or sorting keys will be proposed to the search query requester.

It could be better that search engines pass the user's personal information, such age or gender, to the ranking or sorting selecting. In this case, the search engine pre-defines characters to the each ranking or sorting key. Additional weights or scores will be added to the ranking or sorting keys with the same characters of the search query. For example, on Valentine's Day, a search query of “eat at hotel” has “romantic” character while the ranking or sorting key of “hotel decoration” has the character of “romantic” too. Therefore, additional weight or score will be added to “hotel good view”. Another example, “a birthday party dinner” will put the weight or score for “restaurant size” higher.

When people reading news, stories, or messages over Internet search engine, or a social network, most people just want to see true news or true stories. They don't like to spend time on reading faked news or liar's stories. It is important to assign trueness scores to news, messages, or stories.

Also, it would be better that search engines bring two or more sets of search results by a different sorting or ranking rules, present the two or more sets of results into a single page, and show users the two or more sets of search results in one at one time. For example, divide a single page into two or more columns or blocks, and put the two or more sets of search results into different columns or blocks. There, users are able to see search results in a different sorting or ranking in a single same page, and easy for them to compare results from different sorting or ranking rules. For example, search engines return a search results page with two columns holding one set of results sorting by locations and the other set of results sorting by hot index in a social network.

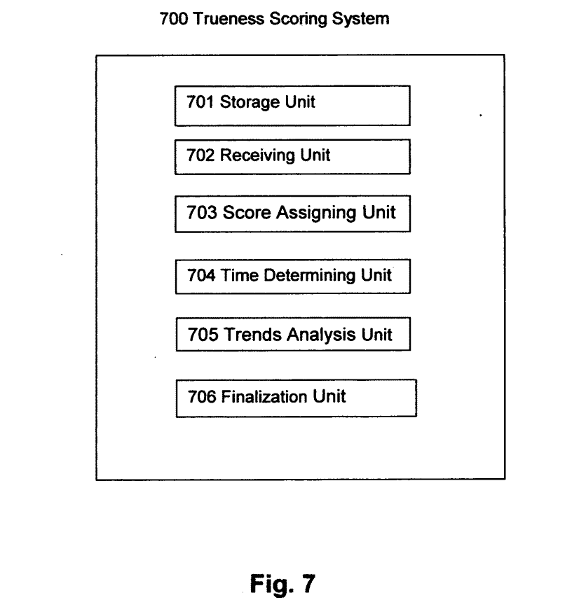

FIG. 7 shows a trueness scoring system 700, which includes a storage unit 701 for storing, for each object, ID, URL, trueness scores, and descriptions; a receiving unit 702 for receiving a trueness scores for a object from users; a score assigning unit 703 for, based on the average of the user's trueness scores or other algorithm, assigning trueness scores to said object, and storing the scores in the storage unit; a time determining unit 704 for determining the life time of said object, which is a news, a message, or a story, and storing the life time period in the storage unit; a trends analysis unit 705 for analyzing the change trends, such as the trends of daily average or hourly average trueness scores collected form users, of the trueness scores of each the object, and, at, or even just after the end of the life time of the object, determining a final trueness scores to the object; finalization unit 706 for, based on the analysis results of the trends analysis unit 705, determining a final score of the object, and storing the final scores in the storage unit 701. Please note that some news or store may don't have a final answer forever. For example, “which came first, the chicken came first”. There is no life time for this message, and no final answer to this question. However, for the news like “Kobe will leave Lakers this summer”, the life time of this object is this summer. Therefore, the end of the life time of this news is the end of this summer. During this summer, many people may believe this news, and give a high trueness scores to this news. By the end of this summer, Kobe still stays in Lakers, and most people, at this time, will give a very low score to this news. The trend of this dramatically change of the trueness scores indicates that the final answer to this news is that Kobe will not leave Lakers, and the trueness score for this news will be very low, no matter how many people give many high trueness scores to this news. This dramatically change by the end of life time of the news also indicates that it is a final score, and will hardly be changed in the future. Therefore, it is not necessary anymore to prompt for users to score trueness for this news. Search engines and news publishers may share their trueness scores information. Therefore, people are able to sort the search results by the order of their trueness sores. The trueness scores for some news are always steadily in same range, always low scores or always high scores, the trueness scores for this kind of news or stories are obvious to the people. For example, “Lakers will win championship in 2009”. The average trueness scores already reflect the real fact. When trueness scores change dramatically by or just after the end of life time, it indicates that the average trueness scores do not reflect the fact. Therefore, the previous average scores trueness scores should be overwritten or replaced by the new trueness scores, which is determined by the finalization unit 706. Off course, some news or stories can be manually determined or adjusted at any time. For any objects, like news, messages, statements, announcement, or stories, which are set to final by the finalization unit 706, there are no needs to collecting trueness scores anymore. Therefore, the search engines, news sites, or other social networks will not collect trueness scores for those objects with final flag set. Since there so many objects around Internet, it is impossible have some real people to review the news, stories, or statements, one by one, and assign the right trueness scores. The automation determination of final trueness scores of objects, like news, stories, announcements, statements, or messages, are very important for those are concerning the real trueness, or using trueness scores to ranking searching results.

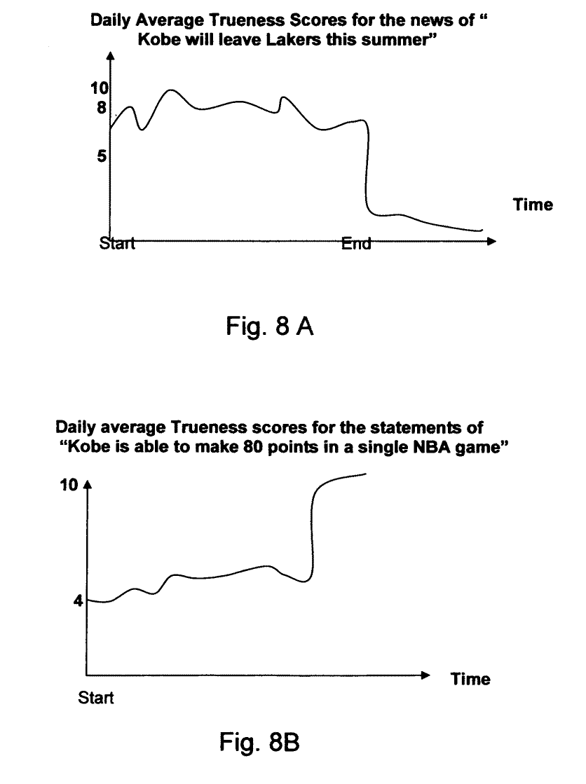

FIG. 8A shows an example of the changes of the average daily trueness scores of the rumor of “Kobe will leave Lakers this summer”. X-axis reprints the time periods, from the time of this of the statement came out to the end of the life time of this statement, example, from the beginning this spring to the end of this summer. At the rumor came out, the beginning of this spring, many people believe it. Therefore, the collected daily average trueness scores are above 8/10 and this will make average of total trueness scores higher than 8/10, which normally will be used for the search engine's ranking algorithms. One day, the end of this summer, everyone realize it is just a rumor not true. Then, the daily average trueness scores dropped like crazy. This dramatically changes of the average daily trueness scores indicate that people got the final answer or knew the result of this statement. At this time, the real trueness scores should be closer to 0. However, the average of total trueness scores is still very higher since so many votes collected before this big change of the daily average trueness scores. Therefore, the finalization unit 706 will, based the dramatically changes of the daily trueness scores, assign a final scores, for example, 1/10. The final scores will replace the total average scores, and will be used for search engine's ranking.

FIG. 8B shows another example of the dramatically changes of the daily average trueness scores for statement of “Kobe is able to make 80 points in a single NBA game”. When the statement came out, not many people believe it although Kobe is currently the best NBA player in the league. One day Kobe did it, and then, the daily trueness scores became higher suddenly. This is indicates that people saw that Kobe did it. The trends analysis unit 705 found out this dramatically change of the daily trueness scores, and instructed the finalization unit 706 to assign a final trueness score 10/10 to this statement, and set a final flag to this statement.

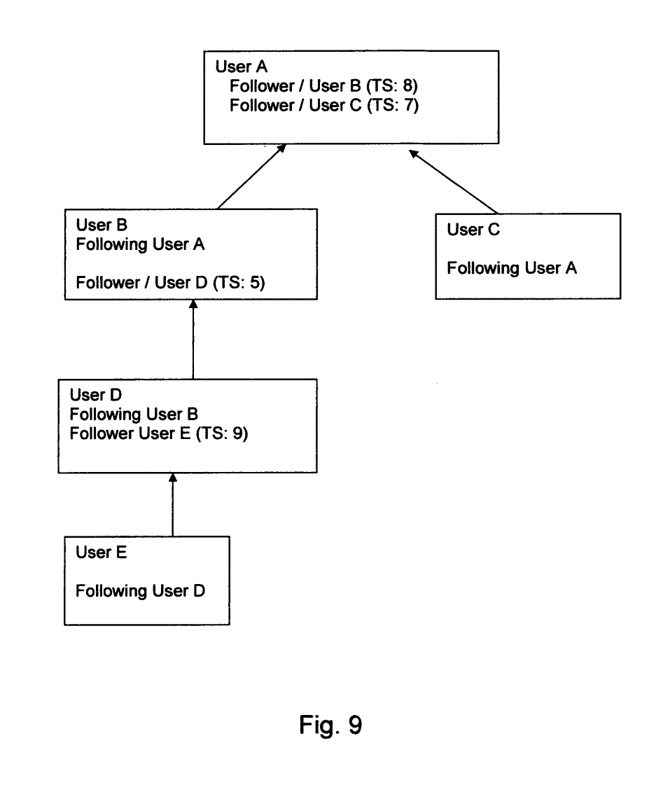

FIG. 9 shows user profiles in a social network. Each user may follow other users or be followed by other users. For each followers, a direct trust score (TS) has been assigned if there is a follower for this user. In FIG. 9, user A has 2 followers user B and User C, and has assigned trust scores (TS) 8 to user B, 7 to user C. User B has a follower, User D with a trust scores (TS) 5. User D has a follower, user E with TS 9. Therefore, user A has an indirect trust scores (TS) 8*5/10=4 for user D, and an indirect trust scores (TS) 8*5/10*9/10=3.6. When a user publish a message (or news), a trueness scores has been assigned to the message. When the trueness score become lower, the trust scores in other users profile for this user will become lower too. In another words, the social network is similar to the real life. When you publish a not true message, your trueness scores in other people's profile will be lower too. The trueness and trust scores system encourage people behavior good in today's social network, like FACEBOOK or TWITTER. Users can use the trust scores of their upper level users (following) or lower level users (follower) to select new uses (following or follower).

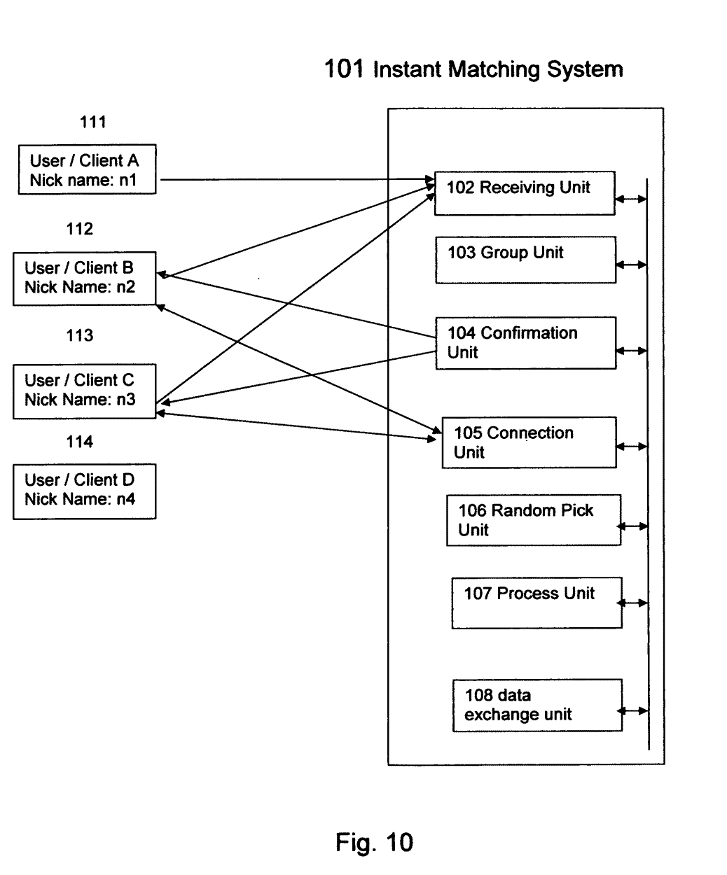

FIG. 10 shows an instant matching system 101 for lunching a matching program, which could be a social activity, a game, an on-line party, TV host program, or sports fans celebration event. The system 101 includes a receive unit 102 for requests of users requesting from their clients to join the lunched program or activity. Group Unit 103 groups the requests by the users preferences in their profiles or the selection of users requesting. It may use the ranking or sorting methods mentioned above to rank or sort people in waiting queues. For example, 112, user B, who is male, would like to connect to a female, while 111, user A and 113, user C are females, who would like to connect a male person. Also, group unit 103 is able to group users by real time data, such as position or location data. People may just want to talk to people in the same town. Group unit 103 divides users A, B, and C into 2 pair groups 1 and 2. Based on the information got from group unit 103, confirmation unit 104 sends confirmation messages to users. In this example, confirmation unit 104 sends confirmation messages, which include call in number and other information, through instant text message system to users B and C. Users B and C call in to connection unit 105, which is a call server, a message server or conference call server. For each call in person in group 1, random pick unit 106 will randomly pick or select one call in person from the other pair of the group, group 2, and process unit 107 controls connection unit 105 to set up connection between the selected two persons, user B and C. In this example, users can send requests for joining matching programs by instant messages, phone call-in, or submit requests from web forms. In another words, receive unit 102 includes a message server for receiving instant messages from previous registered users for requesting to join matching programs launched by system 101. Receive unit 102 may include a web server for receiving request submissions from users for requesting to join the matching programs. Receive unit 102 may include a call center for receiving calls from users for requesting to join the matching programs. Confirmation Unit 104 sends a confirmation message, through instant messages, to users, and tells them, for example, “Your request has been received, and please calls at this number xxx-xxx-xxxx in 10 minutes. Your access code is xxxx.”. Off course, these kind confirmation messages can be sent to users by phone calls or by web pages. Connection unit 106 receives calls and, based on the random selections or picks sets up and maintains a connection between a matched two users. User B and user C are strange to each other. In this case, both user B and user C just call in to connection unit 105 in instant matching system 101, the system, then, automatically picks a partner for them to talk or chat over phones To those who are shy to make a phone to a stranger, the system will work extremely well. They are relaxed and will talk the subjects they are interested. This is a new way to make friends. People don't need to spend time to select who they will chat with, talk or call to. System 101 will automatically randomly pick matched pair persons, and setup, and maintain connections between them. Off course, system 101 can not only pick a matched pair persons, but also can pick matched group people. In this case, connection unit 105 setup the connections among the persons in this group. People in this group will have a conference call to discuss their shared interests. Process unit 107 processes data between or among the different function units, and set up time period for re-pick partners. For example, every 8 minutes, process unit 107 controls random pick unit 105 to pick a partner for each call in users, and controls connection unit 105 to switch the previous connections to and maintain new connections between newly picked pair users.

This is a faster way for people to make friends over social networks. Users just make one call, and are able to talk many strangers one by one. Data exchange unit passes data information, such as videos or pictures between two matched users.

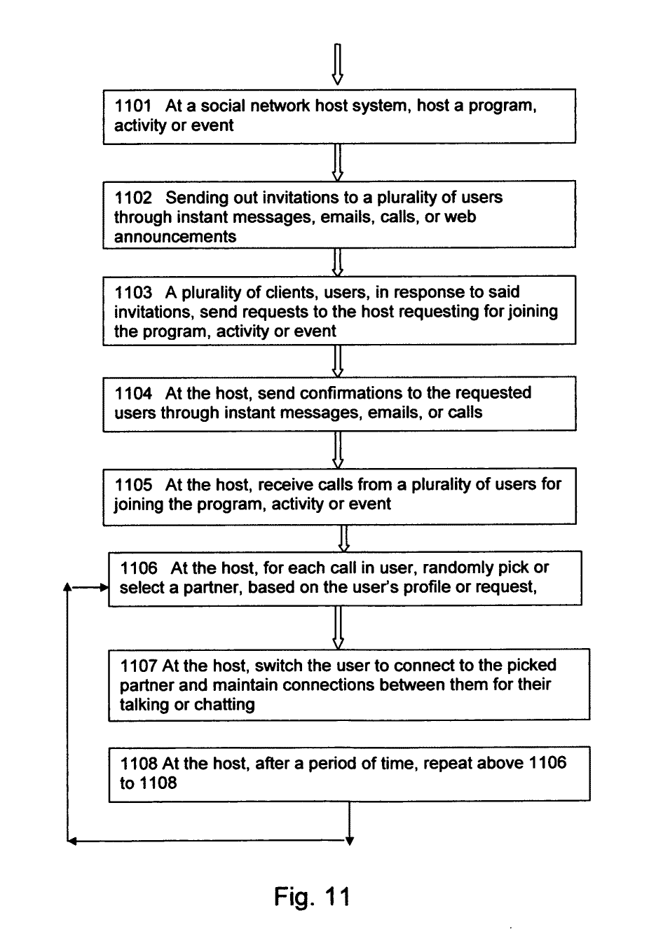

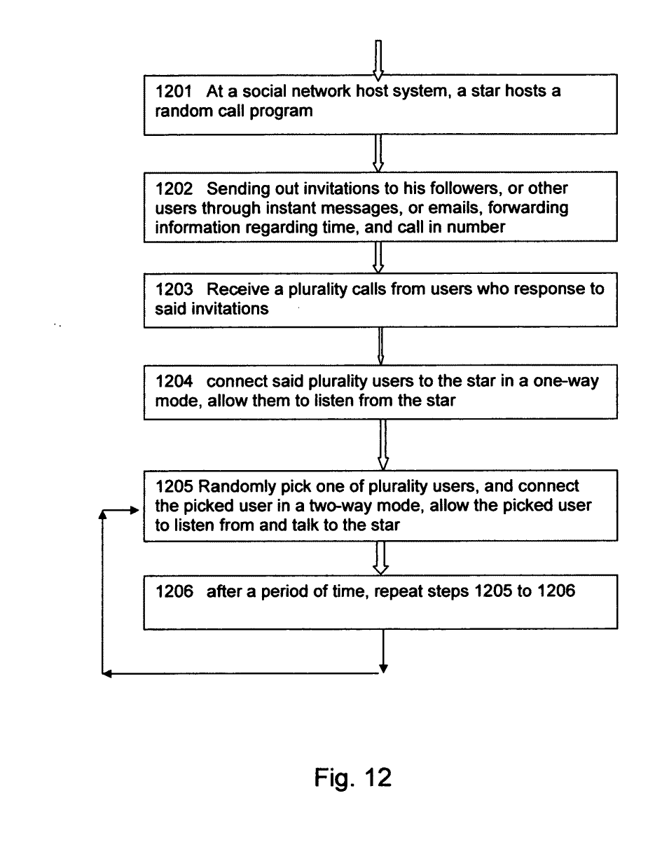

FIG. 11 shows processes of instant matching system. First, in step 1101, at a social network system, such as TWITTER or FACEBOOK, a star (movie star or sports star) hosts a random call program or activity, to interactive with his fans or followers. In step 1102, at the host system, sending our instant messages to his fans or followers, or even other users, inviting them to join the program or activity. In step 1103, at clients of his followers or fans, his followers or fans send requests to the host requesting to join the program or activity, through instant messages or web submissions. In step 1104, at the host system, randomly select or pick at least one person from those requesters. In step 1105, at the host, call the phone of the star and the phone of the picked or selected his follower or fan, at almost the same time, and setup and maintain the connection between the phone of the star and the phone of the follower or the fan. Repeating the above steps, the star is able to interact with his followers or fans.

Although the invention has been described with reference to the above-described embodiments and examples, it will be appreciated that many other variations, modifications, and applications may be devised in accordance with the broad principles of the invention disclosed herein. The invention, including the described embodiments and examples and all related variations, modifications and applications is defined in the following claims.

Therefore, the forgoing is considered as illustrative only of the principles of the invention. Furthermore, since numerous modifications and changes will readily occur to those skilled in the art, it is not desired to limit the invention to the exact construction and operation shown and described. Accordingly, all suitable modifications and equivalents may be resorted to, falling within the scope of the invention.

1. A method of searching information over Internet according to the present invention comprising:
under control of a client system,
entering a search query, and submit it; and
in response to said submit, sending the said search query to a search engine server system,
under control of a search engine server system,
receiving said search query request,
searching in database for results matching said search query,
generating at least one set of search results, ordered by search engine defined ranking or sorting,
determining the other possible ranking or sorting keys for the said search query,
returning said search results and the other possible ranking or sorting keys back to the client system,
under control of the client system,
displaying said search results and the other possible ranking or sorting keys for the said search query for users further selection.

2. A method of searching information over Internet of claim 1 further comprising:
determining possible sub-groups for the each said other possible ranking or sorting keys,
generating a summary for said each subgroup, which includes sub-group's titles, number of the results in each sub-groups, or hot index of each sub-groups,
returning said results, said other possible ranking or sorting keys, and said summaries back to said client system,
under control of said client system,
displaying said results, said other possible ranking or sorting keys for said search query, and said summaries for user's further selection or reference.

3. A method of searching information over Internet of claim 1 wherein;
in said generating step, generate two or more sets of search results, which are ordered by a different sorting or ranking;
in said displaying step, display two or more sets of search results in different columns or blocks in a single page.

4. A trueness scoring system according to the present invention includes:
storage unit for storing a ID, URL, trueness scores, and descriptions for each news, notices, messages, videos, or stories;
receiving unit for receiving trueness scores said news, notices, messages, videos, or stories, which are assigned by users from news sites, search engines, or social networks;
assigning unit for assigning said received trueness scores to corresponding said news, notices, messages, videos, or stories, and storing the truthiness scores in said storage unit;
time determining unit for determining a life time or period for each said news, notices, messages, videos, or stories;
trends analysis unit for analyzing the trends of average trueness scores per certain time of period for said news, notices, messages, videos, or stories;
finalization unit for, based on the trends analysis results, determining whether there is a final trueness scores, and if there is a final trueness scores, assigning a final trueness scores to said news, notices, messages, videos, or stories.

5. A trueness scoring system of claim 4,
wherein said trends analysis unit analyzes the trends of daily or hourly average trueness scores for each said news, notices, messages, videos, or stories.

6. A trueness scoring system of claim 5
wherein said finalization unit assigns a final low scores or zero score to a news, a notice, a message, or a story when the trends of the trueness scores for said news, notice, message or story change dramatically to lower by the end or just after the end of life time of said news, notice, message or story, and assigns a final high scores or full scores to a news, a notice, a message, or a story when the trends of the trueness scores for said news, notice, message or story change dramatically to higher by the end or just after the end of life time of said news, notice, message or story.

7. An instant matching method according to the present invention compromising: under control of a hosting system, this hosts a program, activities or event,
a) receive calls from a plurality of users for joining said program, activity or event;
b) for each user, based on the user's profile or the user's requests, randomly pick or select a matched partner from said plurality of users;
c) switch said user to connect to said picked partner and maintain the connection between the user and the partner for their talking and chatting for a period of time;
d) after said period of time, repeat steps b) to d).

8. An instant matching method of claim 7 further compromising: before said step a),
1) Send invitations to a plurality of users;
2) Receive requests from the users for requesting to join said program, activity or event;
3) Sending confirmation messages to the users, forwarding the information regarding call in numbers, and call in time period.
